(19) United States
(12) Patent Application Publication
(10) Pub. No.: US 2014/0095558 A1
(43) Pub. Date: Apr. 3, 2014

(54) COMPUTING SYSTEM AND METHOD OF MANAGING DATA THEREOF

(71) Applicant: Samsung Electronics Co., Ltd., Suwon-si (KR)

(72) Inventors: CHUL LEE, HWASEONG-SI (KR); JAE-GEUK KIM, HWASEONG-SI (KR); CHANG-MAN LEE, SEOUL (KR); JOO-YOUNG HWANG, SUWON-SI (KR)

(73) Assignee: Samsung Electronics Co., Ltd., Suwon-si (KR)

(21) Appl. No.: 14/038,884

(22) Filed: Sep. 27, 2013

(30) Foreign Application Priority Data
Sep. 28, 2012 (KR) 10-2012-0109182

(51) Int. Cl. G06F 17/30

(52) U.S. Cl. CPC G06F 17/30194
USPC 707/827

(57) ABSTRACT

A computing system includes a virtual file system and a file system. The virtual file system is configured to provide a first data request to read first file data. The file system is configured to receive the first data request, to read first metadata and second metadata from a storage device in response to the first data request, and then to read first file data corresponding to the first metadata and second file data corresponding to the second metadata from the storage device.

### CROSS-REFERENCE TO RELATED APPLICATIONS

A claim for priority under 35 U.S.C. §119 is made to Korean Patent Application No. 10-2012-0109182, filed on Sep. 28, 2012, in the Korean Intellectual Property Office, the entire contents of which are hereby incorporated by reference.

### BACKGROUND

The inventive concept relates to a computing system and a data management method thereof.

When a file system operates to store a file in a storage device, the file system stores file data and metadata in the storage device. The file data includes contents of the file that a user application intends to store, and the metadata includes attributes of the file and positions of blocks in which the file data is stored.

Further, when the file system operates to read the file from the storage device, the file system reads the file data and the metadata, which are stored in the storage device, from the storage device.

### SUMMARY

Embodiments of the inventive concept provide a computing system which can increase file reading speed. Also, embodiments of the inventive concept provide a data management method of a computing system, which can increase file reading speed.

Additional advantages, subjects, and features of the inventive concept will be set forth in part in the description which follows and in part will become apparent to those having ordinary skill in the art upon examination of the following or may be learned from practice of the inventive concept.

According to an aspect of the inventive concept, there is provided a computing system including a virtual file system and a file system. The virtual file system is configured to provide a first data request to read first file data. The file system is configured to receive the first data request, to read first metadata and second metadata from a storage device in response to the first data request, and then to read first file data corresponding to the first metadata and second file data corresponding to the second metadata from the storage device.

According to another aspect of the inventive concept, there is provided a data management method of a computing system data having a storage device. The method includes receiving a first data request to read first file data from the storage device, reading first metadata and second metadata from the storage device in response to the request, and reading first file data corresponding to the first metadata and second file data corresponding to the second metadata from the storage device. The first file data is provided to a user application.

According to another aspect of the inventive concept, there is provided a computing system including a storage device configured to store a plurality of data and a plurality of metadata corresponding to the plurality of data, and a host configured to communicate with the storage device. The host includes a user application, a virtual file system and a file system. The user application is configured to provide a first data request to read first file data of the plurality of data in the storage device. The virtual file system is configured to receive the first data request from the user application. The file system is configured to receive the first data request from the virtual file system, to read first metadata and second metadata from the storage device in response to the first data request, and then to read the first file data from the storage device using the first metadata and second file data of the plurality of data from the storage device using the second metadata. One of the virtual file system and the file system is configured to provide a second data request for reading the second file data in response to the first data request.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram of a computing system, according to embodiments of the inventive concept.

FIG. 2 is a block diagram of a host of FIG. 1, according to embodiments of the inventive concept.

FIG. 3 is a block diagram explaining the structure of a file stored in a storage device of FIG. 1, according to embodiments of the inventive concept.

FIG. 4 is a flow diagram showing a data management method of the computing system of FIG. 1, according to a first embodiment of the inventive concept.

FIG. 5 is a flowchart explaining a data management method of a computing system, according to a second embodiment of the inventive concept.

FIG. 6 is a flowchart explaining a data management method of a computing system, according to a third embodiment of the inventive concept.

FIG. 7 is a flowchart explaining a data management method of a computing system, according to a fourth embodiment of the inventive concept.

FIGS. 8 and 10 are block diagrams explaining a storage device of FIG. 1, according to an embodiment of the inventive concept.

FIG. 9 is a diagram explaining structure of a file stored in the storage of FIG. 1, according to an embodiment of the inventive concept.

FIG. 11 is a diagram of a node address table, according to an embodiment of the inventive concept.

FIGS. 12 and 13 are conceptual diagrams explaining a data management method of the computing system, according to embodiments of the inventive concept.

FIG. 14 is a block diagram explaining structure of a storage device of FIG. 1, according to another embodiment of the inventive concept.

FIG. 15 is a block diagram explaining structure of a storage device of FIG. 1, according to another embodiment of the inventive concept.

FIG. 16 is a block diagram explaining structure of a storage device of FIG. 1, according to another embodiment of the inventive concept.

FIG. 17 is a block diagram explaining an example of a computing system, according to embodiments of the inventive concept.

FIGS. 18 to 20 are block diagrams illustrating another example of a computing system according to embodiments of the inventive concept.

### DETAILED DESCRIPTION OF THE EMBODIMENTS

The inventive concept will now be described more fully with reference to the following detailed description and accompanying drawings, in which exemplary embodiments of the inventive concept are shown. The inventive concept may, however, be embodied in many different forms and should not be construed as being limited to the embodiments set forth herein. Rather, these embodiments are provided so that this disclosure will be thorough and complete, and will fully convey the concept of the inventive concept to one of ordinary skill in the art. Thus, in some embodiments, well-known methods, procedures, components, and circuitry have not been described in detail to avoid unnecessarily obscuring aspects of the present invention.

It will be understood that, although the terms first, second, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “comprising,” when used in this specification, specify the presence of the stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. The term “exemplary” indicates an illustration or example.

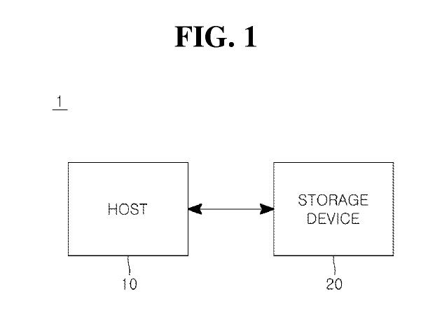

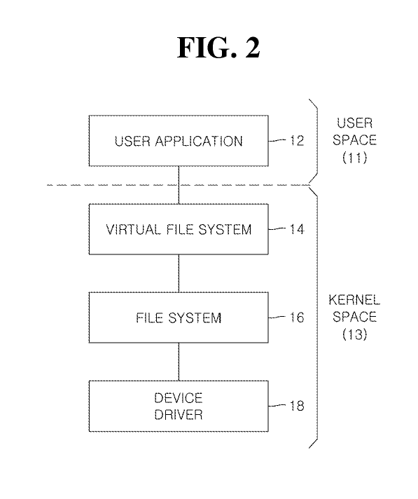

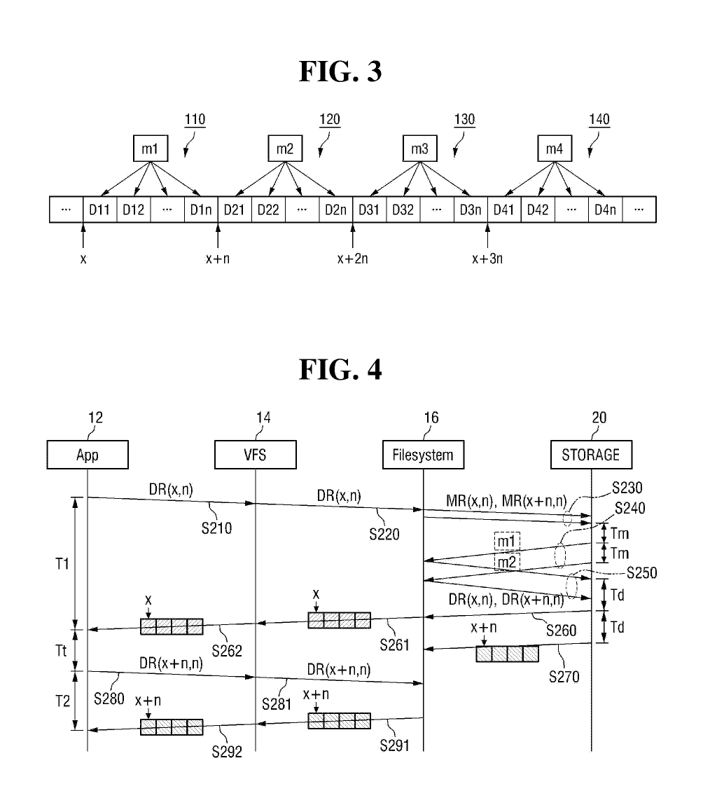

FIG. 1 is a block diagram of a computing system, according to an embodiment of the inventive concept. FIG. 2 is a block diagram of a host of FIG. 1, according to an embodiment. FIG. 3 is a block diagram of a structure of a file stored in the storage device of FIG. 1, according to an embodiment. FIG. 4 is a flow diagram showing a data management method of the computing system of FIG.1, according to a first embodiment of the inventive concept.

First, referring to FIG. 1, a computing system 1 includes a host 10 and a storage device 20. The host 10 and the storage device 20 communicate with each other using a specific protocol. For example, the host 10 and the storage device 20 may communicate with each other via at least one of various interface protocols, such as a Universal Serial Bus (USB) protocol, a Multimedia Card (MMC) protocol, a Peripheral Component Interconnection (PCI) protocol, a PCI-Express (PCI-E) protocol, an Advanced Technology Attachment (ATA) protocol, a Serial ATA (SATA) protocol, a Parallel-ATA protocol (PATA), a Small Computer Small Interface (SCSI) protocol, an Enhanced Small Disk Interface (ESDI) protocol, and an Integrated Drive Electronics (IDE) protocol. However, the interface protocols are not limited thereto.

The host 10 controls the storage device 20. For example, the host 10 may write data in the storage device 20 and/or read the data from the storage device 20. The storage device 20 may be one of various kinds of card storages, such as Solid State Drive (SSD), Hard Disk Drive (HDD), and eMMC, or a data server, but is not limited thereto.

Referring to FIG. 2, the host 10 includes a user space 11 and a kernel space 13. The user space 11 is a region in which a user application 12 is executed, and the kernel space 13 is a restrictively reserved region to execute kernel. In order for the user space 11 to access the kernel space 13, a system call may be used.

In the depicted embodiment, the kernel space 13 includes a virtual file system 14, a file system 16, and a device driver 18. The file system 16 may be implemented using one or more file systems 16. For example, the file systems 16 may be ext2, ntfs, smbfs, proc, flash-friendly file system (F2FS), and the like. Particularly, in the computing system 1 according to the first embodiment, the file system may perform reading ahead of metadata.

The virtual file system 14 enables one or more file systems 16 to operate with each other. In order to perform read/write tasks with respect to different file systems 16 of different media, standardized system calls may be used. For example, system calls, such as open( ), read( ), and write( ), may be used regardless of the kind of the file systems 16. That is, the virtual file system 14 is an abstract layer that exists between the user space 11 and the file system 16. Further, in the computing system 1 according to the first embodiment, the virtual file system 14 may perform reading ahead of file data.

The device driver 18 controls an interface between hardware and a user application (or operating system). The device driver 18 is a program that is necessary for the hardware to normally operate under a specific operating system.

Referring to FIG. 3, when the file system 16 intends to store a file in the storage device 20, the file system 16 stores file data D11 to D1n, D21 to D2n, D31 to D3n, and D41 to D4n and corresponding metadata m1, m2, m3, and m4, respectively, in the storage device 20. The file data D11 to D1n, D21 to D2n, D31 to D3n, and D41 to D4n include the contents of the file that the user application 12 intends to store, and the metadata m1, m2, m3, and m4 include the attributes of the file and the positions of blocks in which the file data D11 to D1n, D21 to D2n, D31 to D3n, and D41 to D4n are stored. When the file system 16 intends to read the file from the storage device 20, the file system 16 reads the file data D11 to D1n, D21 to D2n, D31 to D3n, and D41 to D4n and the corresponding metadata m1, m2, m3, and m4, respectively, which are stored in the storage device 20, from the storage device 20.

Illustrative files 110, 120, 130, and 140 may have an indexing structure as illustrated in FIG. 3. For convenience in explanation, in FIG. 3, the illustrated indexing structure is simplified.

For example, the first file 110 includes the first metadata m1 and the first file data D11 to D2n. The first file data D11 to D1n may be stored in n file data blocks, starting from a file data block that corresponds to an address x. The first file data D11 to D1n can be found using the first metadata m1. The second file 120 includes the second metadata m2 and the second file data D21 to D1n. The second file data D21 to D2n may be stored in n file data blocks, starting from a file data block that corresponds to an address x+n. The second file data D21 to D2n can be found using the second metadata m2. In the same manner, the third file 130 includes the third metadata m3 and the third file data D31 to D3n, and the fourth file 140 includes the fourth metadata m4 and the fourth file data D41 to D4n.

Exemplarily, it is illustrated that each of the first to fourth files 110 to 140 include n file data blocks, but the embodiments are not limited thereto. For example, the first to fourth files 110 to 140 may have different numbers of file data blocks. Further, it is illustrated that the first to fourth files 110 to 140 are adjacent to each other, but the embodiments are not limited thereto.

Referring to FIGS. 1 to 4, a first data request DR (x, n) is a request to read the first file data D11 to D1n stored in n file data blocks, starting from the file data block that corresponds to the address x. A second data request DR (x+n, n) is a request to read the second file data D21 to D2n in n file data blocks, starting from the file data block that corresponds to the address x+n. A first metadata request MR (x, n) is a request to read the first metadata m1 that corresponds to the first file data D11 to D1n. A second metadata request MR (x+n, n) is a request to read the second metadata m2 that corresponds to the second file data D21 to D2n.

The user application 12 provides the first data request DR (x, n) to read the first file data D11 to D1n to the virtual file system 14 (S210). Then, the virtual file system 14 provides the first data request DR (x, n) to read the first file data D11 to D1n to the file system 16 (S220).

The file system 16 provides the first metadata request MR (x, n) to read the first metadata m1 and the second metadata request MR (x+n, n) to read the second metadata m2 to the storage device 20 (S230). The file system 16 reads the first metadata m1 and the second metadata m2 from the storage device 20 (S240). Time Tm indicates time required for reading the respective metadata m1 and m2. Using the first and second metadata m1 and m2, respectively, the file system 16 provides the storage device 20 the first data request DR (x, n) to read the first file data D11 to D1n and a second data request DR (x+n, n) to read the second file data D21 to D2n (S250). In response, the storage device 20 provides the file system 16 the first file data D11 to D1n corresponding to the first metadata m1 and the second file data D21 to D2n corresponding to the second metadata m2 (S260 and S270). Time Td indicates time required for reading the respective file data D11 to D1n and D21 to D2n after reading the corresponding metadata m1 and m2.

The second file data D21 to D2n are data that are expected to be read next to the first file data D11 to D1n. For example, the second file data D21 to D2n may be located adjacent (just after or just before) the first file data D11 to D1n.

The file system 16 provides the read first file data D11 to D1n to the virtual file system 14 (S261), and the virtual file system 14 transfers the first file data D11 to D1n to the user application 12 (S262). Time T1 indicates time required for the user application 12 to receive the first file data D11 to D1n after providing the first data request DR (x, n).

After time Tt (think time), the user application 12 provides the second data request DR (x+n, n) to read the second file data D21 to D2n to the virtual file system 14 (S280). Then, the virtual file system 14 provides the second data request DR (x+n, n) to read the second file data D21 to D2n to the file system 16 (S281).

The file system 16 provides the read-ahead (previously read) second file data D21 to D2n to the virtual file system 14 (S291). The virtual file system 14 provides the second file data D21 to D2n to the user application (S292). Time T2 indicates time required for the user application 12 to receive the second file data D21 to D2n after providing the second data request DR (x+n, n).

Accordingly, in the computing system 1 according to the first embodiment, the file system 16 performs reading ahead of metadata. That is, even when the file system 16 receives a request to read just one file data (for example, D11 to D1n), the file system 16 reads multiple metadata (for example, m1 and m2). As illustrated, when the file system 16 receives the first data request DR (x, n) to read the first file data D11 to D1n, the file system 16 generates the first metadata request MR (x, n) to read the first metadata m1 corresponding to the first file data D11 to D1n, as well as the second metadata request MR (x+n, n) to read the second metadata m2 corresponding to the second file data D21 to D2n. The number of metadata to be reading ahead may vary, e.g., depending on the system to which the inventive concept is applied, without departing from the scope of the present teachings.

In various embodiments, the reading ahead of metadata may be conditionally performed. For example, the file system 16 may determine whether to perform the reading ahead of metadata, and perform the corresponding operation depending on the result of the determination. On the other hand, the file system 16 may unconditionally perform reading ahead of file data without a separate determination.

When the file system 16 performs the reading ahead of metadata, file reading speed is improved (increased). This is because the time required to transmit the first file data D11 to D1n to the file system 16 (e.g., in step S260) and the time required to read the second file data D21 to D2n (e.g., Td) may overlap.

Further, the time T2 is considerably shorter than the time T1. This is because the file system 16 holds the second file data D21 to D2n in advance by performing the reading ahead of metadata. Notably, when the user application does not use the time Tt, the file reading speed can be further improved.

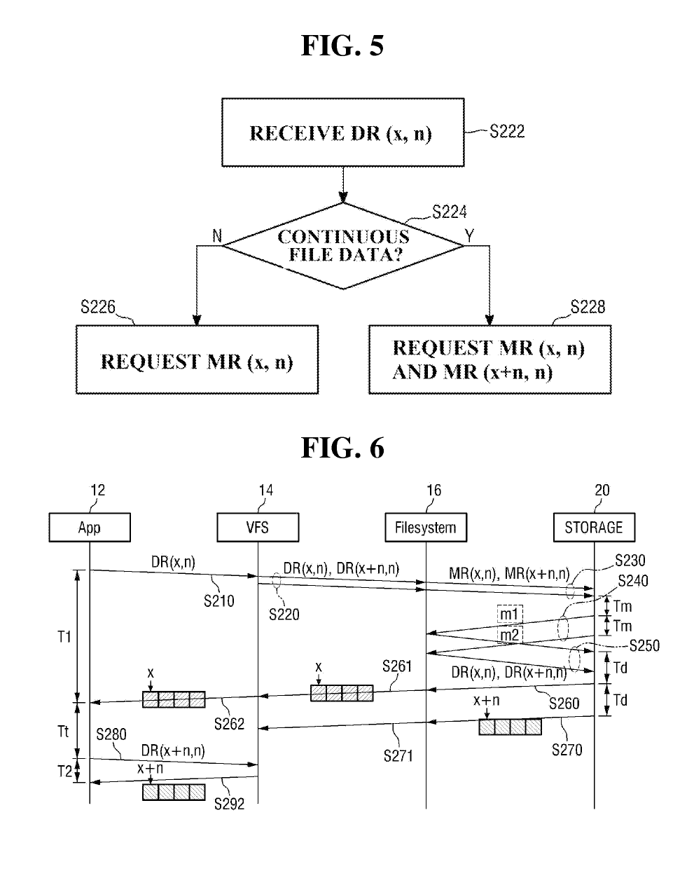

FIG. 5 is a flowchart showing a data management method of a computing system, according to a second embodiment of the inventive concept. For convenience, explanation of the same components and/or operations described above with reference to FIGS. 1 to 4 may not be repeated.

Referring to FIG. 5, in the data management method of the computing system according to the second embodiment, the file system 16 determines whether to perform the reading ahead of metadata, and performs the corresponding operation depending on the result of the determination. Although various determination methods may be adopted, it is assumed that whether to perform the reading ahead of metadata is determined through examination of the continuity of the file data in FIG. 5.

For example, the file system 16 receives the first data request DR (x, n) to read the first file data D11 to D1n from the virtual file system 14 (S222). The file system 16 (or the virtual file system 14) determines whether the read-requested file data has continuity with previously requested data (S224). For example, the file system 16 (or the virtual file system 14) may determine whether previously requested third file data D31 to D3n is continuous with the currently requested first file data D11 to D1n.

When the third file data D31 to D3n and the first file data D11 to D1n are continuous with each other, the file system 16 determines that there is a possibility of requesting other continuous file data thereafter. Accordingly, the file system 16 generates the first metadata request MR (x, n) to read the first metadata m1 and the second metadata request MR (x+n, n) to read the second metadata m2 (S228). As described above, the second metadata m2 corresponds to the second file data D21 to D2n, and the second file data D21 to D2n are data that are expected to be read next to the first file data D11 to D1n.

When the third file data D31 to D3n and the first file data D11 to D2n are not continuous with each other, the file system 16 determines that there is little possibility of requesting other continuous file data thereafter. Accordingly, the file system 16 generates only the first metadata request MR (x, n) to read the first metadata ml (S226). The file system 16 does not generate the second metadata request MR (x+n, n) to read the second metadata m2.

FIG. 6 is a flow diagram showing a data management method of a computing system, according to a third embodiment of the inventive concept. For convenience, explanation of the same components and/or operations described above with reference to FIGS. 1 to 4 may not be repeated.

Referring to FIG. 6, in the data management method of the computing system according to the third embodiment, the file system 16 may perform reading ahead of metadata, and the virtual file system 14 may perform reading ahead of file data.

For example, the user application 12 provides the first data request DR (x, n) to read the first file data D11 to D1n to the virtual file system 14 (S210). Then, the virtual file system 14 provides the first data request DR (x, n) to read the first file data D11 to D1n and the second data request DR (x+n, n) to read the second file data D21 to D2n to the file system 16 (S220). That is, even when the user application 12 does not request to read the second file data D21 to D2n, the virtual file system 14 provides the second data request DR (x+n, n) to read the second file data D21 to D2n. The second file data D21 to D2n are data that are expected to be read next to the first file data D11 to D1n. The second file data D21 to D2n may be located adjacent (just after or just before) the first file data D11 to D1n.

The virtual file system 14 may determine whether to perform reading ahead of file data after receiving the first data request DR (x, n). For example, when the previously requested file data and the currently requested file data from the user application 12 are continuous with each other, the virtual file system 14 may perform the reading ahead of file data. On the other hand, the virtual file system 14 may unconditionally perform reading ahead of file data without a separate determination.

The file system 16 provides the first metadata request MR (x, n) to read the first metadata ml and the second metadata request MR (x+n, n) to read the second metadata m2 to the storage device 20 (S230). The file system 16 reads the first metadata m1 and the second metadata m2 from the storage device 20 (S240).

Using the first and second metadata m1 and m2, respectively, the file system 16 provides the storage device 20 the first data request DR (x, n) to read the first file data D11 to D1n and a second data request DR (x+n, n) to read the second file data D21 to D2n (S250). In response, the storage device 20 provides the file system 16 the first file data D11 to D1n corresponding to the first metadata ml and the second file data D21 to D2n corresponding to the second metadata m2 (S260 and S270).

The file system 16 provides the read first file data D11 to D1n and the second file data D21 to D2n to the virtual file system 14 (S261 and S271). The virtual file system 14 transfers the first file data D11 to D1n to the user application 12 (S262). After the time Tt (think time), the user application 12 provides the second data request DR (x+n, n) to read the second file data D21 to D2n to the virtual file system 14 (S280). The virtual file system 14 provides the read-ahead (previously read) second file data D21 to D2n to the user application 12 (S292) in response.

When the virtual file system 14 performs the reading ahead of file data and the file system 16 performs the reading ahead of metadata, the file reading speed can be improved. The time T2 is considerably shorter than the time T1. This is because the virtual file system 14 holds the second file data D21 to D2n in advance by the file system 16 performing the reading ahead of metadata.

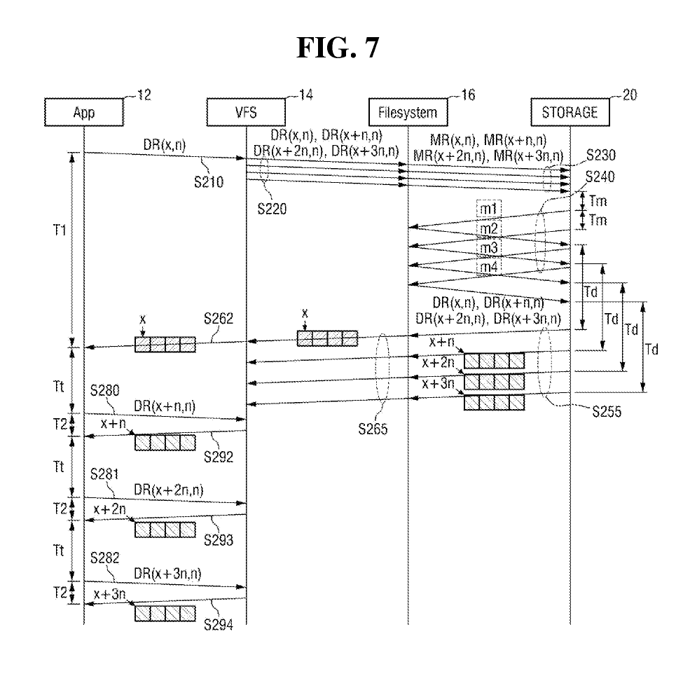

FIG. 7 is a flow diagram showing a data management method of a computing system, according to a fourth embodiment of the inventive concept. For convenience, explanation of the same components and/or operations described above with reference to FIGS. 1 to 4 may not be repeated.

Referring to FIG. 7, in the data management method of the computing system according to the fourth embodiment, the file system 16 may perform reading ahead of three or more metadata, and the virtual file system 14 may perform reading ahead of three or more file data. Exemplarily, as illustrated in FIG. 7, the file system 16 performs the reading ahead of four metadata and the virtual file system 14 performs the reading ahead of four file data, but embodiments of the inventive concept are not limited thereto.

For example, the user application 12 provides the first data request DR (x, n) to read the first file data D11 to D1n to the virtual file system 14 (S210). Then, the virtual file system 14 provides the file system 16 first data request DR (x, n) to read the first file data D11 to D1n, second data request DR (x+n, n) to read the second file data D21 to D2n, third data request DR (x+2n, n) to read the third file data D31 to D3n, and fourth data request DR (x+3n, n) to read the fourth file data D41 to D4n (S220). The file system 16 provides the storage device 20 first metadata request MR (x, n), second metadata request MR (x+n, n), third metadata request MR (x+2n, n), and fourth metadata request MR (x+3n, n) to read the first to fourth metadata m1, m2, m3, and m4 (S240), respectively.

The file system 16 reads the first to fourth file data D11 to D1n, D21 to D2n, D31 to D3n, and D41 to D4n corresponding to the first to fourth metadata m1, m2, m3, and m4 from the storage device 20 (S255). That is, using the first to fourth metadata m1 to m4, respectively, the file system 16 provides the storage device 20 the first data request DR (x, n) to read the first file data D11 to D1n, the second data request DR (x+n, n) to read the second file data D21 to D2n, the third data request DR (x+2n, n) to read the third file data D31 to D3n, and the fourth data request DR (x+3n, n) to read the fourth file data D41 to D4n.

The file system 16 provides the read first to fourth file data D11 to D1n, D21 to D2n, D31 to D3n, and D41 to D4n to the virtual file system 14 (S265). The virtual file system 14 transfers the first file data D11 to D1n to the user application 12 (S262).

After the time Tt, the user application 12 provides the second data request DR (x+n, n) to the virtual file system 14 to read the second file data D21 to D2n (S280), and the virtual file system 14 provides the read-ahead second file data D21 to D2n to the user application (S292). Then, after the time Tt, the user application 12 provides the third data request DR (x+2n, n) to the virtual file system 14 to read the third file data D31 to D3n (S281), and the virtual file system 14 provides the read-ahead third file data D31 to D3n to the user application (S293). Then, after the time Tt, the user application 12 provides the fourth data request DR (x+3n, n) to the virtual file system 14 to read the fourth file data D41 to D4n (S282), and the virtual file system 14 provides the read-ahead fourth file data D41 to D4n to the user application (S294).

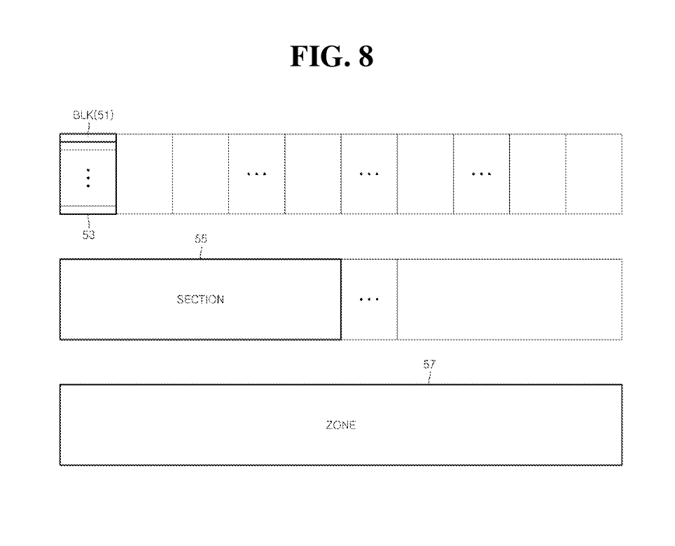

The data management method of the computing system as described above using FIGS. 1 to 7 may be applied to an F2FS file system. Hereinafter, the F2FS file system will be described with reference FIGS. 8 to 17.

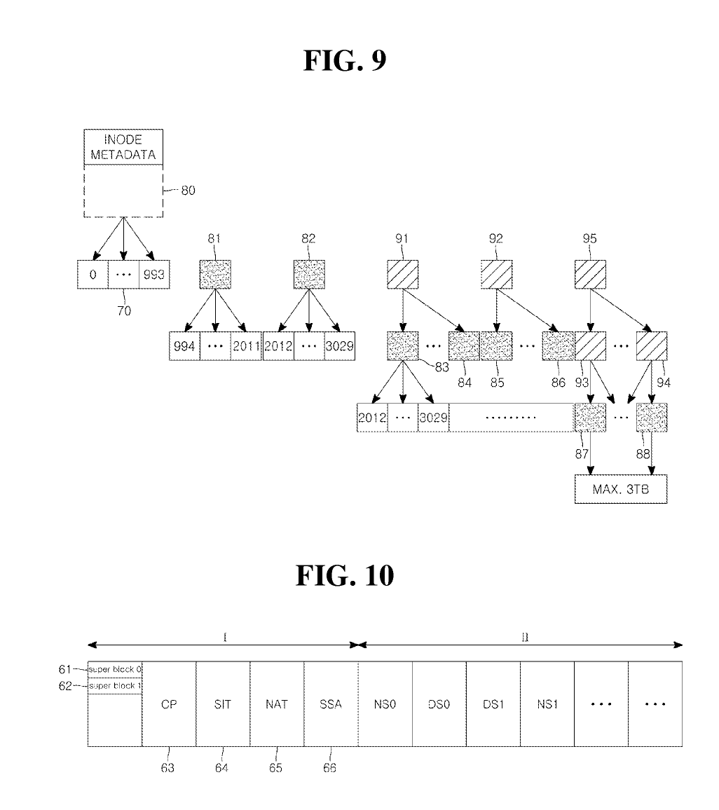

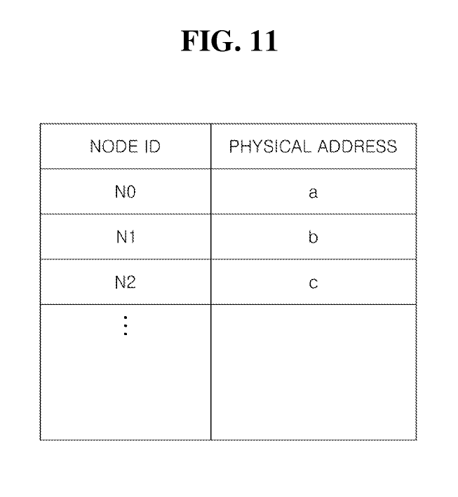

FIGS. 8 and 10 are block diagrams explaining the storage device of FIG. 1, according to an embodiment of the inventive concept. FIG. 9 is a diagram explaining the structure of a file stored in the storage of FIG. 1, according to an embodiment of the inventive concept. FIG. 11 is a diagram explaining a node address table, according to an embodiment of the inventive concept.

The F2FS may manage the storage device 20 as illustrated in FIG. 8. A segment (SEGMENT) 53 includes a plurality of blocks (BLK) 51, a section (SECTION) 55 includes a plurality of segments 53, and a zone (ZONE) 57 includes a plurality of sections 55. For example, the block 51 may have a size of 4 Kbytes, and the segment 53 may include 512 blocks 51, so that each segment 53 has a size of 2 Mbytes. Such a configuration may be determined when the storage device 20 is formatted, although the various embodiments are not limited thereto. The sizes of the section 55 and the zone 57 may be corrected at the time of formatting. In the F2FS, for example, all data may be read/written in page units of 4 Kbyte. That is, one page may be stored in the block 51, and multiple pages may be stored in the segment 53.

A file that is stored in the storage device 20 may have an indexing structure as illustrated in FIG. 9. One file may include a plurality of data and a plurality of nodes, which are related to the plurality of data. Data blocks 70 are regions to store data, and node blocks 80, 81 to 88, and 91 to 95 are regions to store nodes.

The file data (for example, the first file data D11 to D1n) as described above with reference to FIGS. 1 to 7 may be stored in file blocks 70, and the metadata (for example, the first metadata m1) may be stored in node blocks 80, 81 to 88, and/or 91 to 95. That is, in FIGS. 1 to 7, reading the file data may be reading the data stored in the file blocks 70, and reading the metadata may be reading the data stored in the node blocks 80, 81 to 88, and 91 to 95.

The node blocks 80, 81 to 88, and 91 to 95 may include direct node blocks 81 to 88, indirect node blocks 91 to 95, and an Mode block 80. The direct node blocks 81 to 88 include data pointers directly indicating the data blocks 70. The indirect node blocks 91 to 95 include pointers indicating other node blocks (that is, lower node blocks) 83 to 88 which are not the data blocks 70. The indirect node blocks 91 to 95 may include, for example, first indirect node blocks 91 to 94 and a second indirect node block 95. The first indirect node blocks 91 to 94 include first node pointers indicating the direct node blocks 83 to 88. The second indirect node block 95 includes second node pointers indicating the first indirect node blocks 93 and 94.

The Mode block 80 may include at least one of data pointers, the first node pointers indicating the direct node blocks 81 and 82, second node pointers indicating the first indirect node blocks 91 and 92, and a third node pointer indicating the second indirect node block 95. One file may be of 3T byte at maximum, for example, and this large-capacity file may have the following index structure. For example, 994 data pointers are provided in the Mode block 80, and the 994 data pointers may indicate 994 data blocks 70. Two first node pointers are provided, and each of the two first node pointers may indicate two direct node blocks 81 and 82. Two second code pointers are provided, and the two second node pointers may indicate two first indirect node blocks 91 and 92. One third node pointer is provided, and may indicate the second indirect node blocks 95. Further, Mode pages including Mode metadata by files exist.

Meanwhile, as shown in FIG. 10, the storage device 20 is divided into a first area I and a second area II. The file system 16 may divide the storage device 20 into the first area I and the second area II during formatting, although the various embodiments are not limited thereto. The first area I is a space in which various kinds of information managed by the whole system are stored, for example, and may include information on the number of currently allocated files, the number of valid pages, and position information. The second area II is a space in which various kinds of directory information that a user actually uses, data, and file information, and the like, are stored. For example, the file data (for example, first file data D11 to D1n) and the metadata (for example, the first metadata m1) as described above with reference to FIGS. 1 to 7 may be stored in the second area II.

Further, the first area I may be stored in a front portion of the storage device 20, and the second area II may be stored in a rear portion of the storage device 20. Here, the front portion means the portion that is in front of the rear portion based on physical addresses.

More specifically, the first region I may include superblocks 61 and 62, a check point area (CP) 63, a segment information table (SIT) 64, a node address table (NAT) 65, and a segment summary area (SSA) 66. Default information of the file system 16 is stored in the superblocks 61 and 62. For example, information such as the size of the blocks 51, the number of blocks 51, status flags (clean, stable, active, logging, and unknown) may be stored. As illustrated, two superblocks 61 and 62 may be provided, and the same contents may be stored in the respective superblocks 61 and 62. Accordingly, even if a problem occurs in one of the super blocks 61 and 62, the other may be used.

Check points are stored in a check point area 63. A check point is a logical breakpoint, and the states up to the breakpoint are completely preserved. If trouble occurs during operation of the computing system (for example, shutdown), the file system 16 may restore the data using the preserved check point. Such a check point may be generated periodically, at the time of mounting, or at the time of system shutdown, for example, although the various embodiments are not limited thereto.

As illustrated in FIG. 11, the node address table (NAT) 65 may include node identifiers (NODE ID) corresponding to the respective nodes and physical addresses corresponding to the node identifiers. For example, a node block corresponding to the node identifier N0 may correspond to a physical address a, a node block corresponding to the node identifier N1 may correspond to a physical address b, and a node block corresponding to the node identifier N2 may correspond to a physical address c. All nodes (Mode, direct nodes, and indirect nodes) have inherent node identifiers, which may be allocated from the node address table 65. The node address table 65 may store the node identifier of the Mode, the node identifiers of the direct nodes, and the node identifiers of the indirect nodes. The respective physical addresses corresponding to the respective node identifiers may be updated.

The segment information table (SIT) 64 includes the number of valid pages of each segment and bit maps of the pages. The bit map indicates whether each page is valid, indicated as “0” or “1”. The segment information table 64 may be used in a cleaning task (or garbage collection). In particular, the bit map may reduce unnecessary read requests when the cleaning task is performed, and may be used to allocate the blocks during adaptive data logging.

The segment summary area (SSA) 66 is an area in which summary information of each segment of the second area II is gathered. In particular, the segment summary area 66 describes node information about nodes for blocks of each segment of the second area II. The segment summary area 66 may be used for cleaning tasks (or garbage collection). Specifically, in order to confirm the positions of the data blocks 70 or lower node blocks (e.g., direct node blocks), the node blocks 80, 81 to 88, and 91 to 95 have a node identifier list or addresses of node identifiers. By contrast, the segment summary area 66 provides indexes by which the data blocks 70 or the lower node blocks 80, 81 to 88, and 91 to 95 can confirm positions of higher node blocks 80, 81 to 88, and 91 to 95. The segment summary area 66 includes a plurality of segment summary blocks. One segment summary block has information on one segment located in the second area II. Further, the segment summary block is composed of multiple portions of summary information, and one portion of summary information corresponds to one data block or one node block.

The second area II may include data segments DS0 and DS1 and node segments NS0 and NS1, which are separated from each other. The plurality of data may be stored in the data segments DS0 and DS1, and the plurality of nodes may be stored in the node segments NS0 and NS1. That is, as described above using FIGS. 1 to 7, the file data (for example, the first file data D11 to D 1n) may be stored in the data segments DS0 and DS1, and the metadata (for example, the first metadata m1) may be stored in the node segments NS0 and NS1. If the data and the nodes are separated in different areas, the segments can be effectively managed, and the data can be read more effectively in a short time.

Further, write operations in the second area II may be performed using a sequential access method, while write operations in the first area I may be performed using a random access method. As mentioned above, the second area II may be stored in the rear portion of the storage device 20, and the first area I may be stored in the front portion of the storage device 20 in view of physical addresses.

The storage device 20 may be a Solid State Drive (SSD), in which case a buffer may be provided in the SSD. The buffer may be a single layer cell (SLC) memory, for example, having fast read/write operation speed. Therefore, the buffer may increase the write speed in the random access method in a limited space. Accordingly, by locating the first area I on the front portion of the storage device 20, using such a buffer, deterioration of performance may be prevented.

In FIG. 10, the first area I includes the superblocks 61 and 62, the check point area 63, the segment information table 64, the node address table 65, and the segment summary area 66, which are arranged in that order, although the various embodiments are not limited thereto. For example, the positions of the segment information table 64 and the node address table 65 may be exchanged, and the positions of the node address table 65 and the segment summary area 66 may be exchanged.

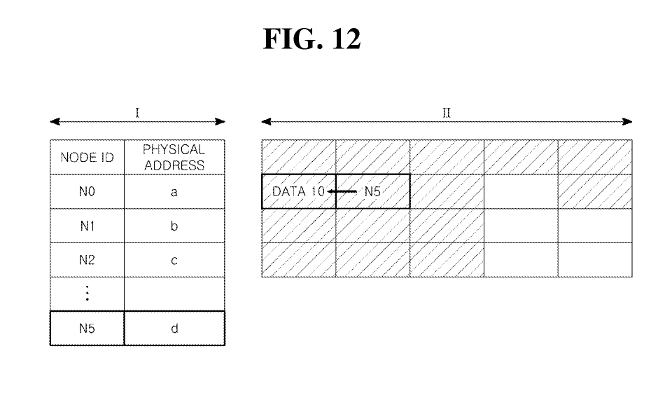

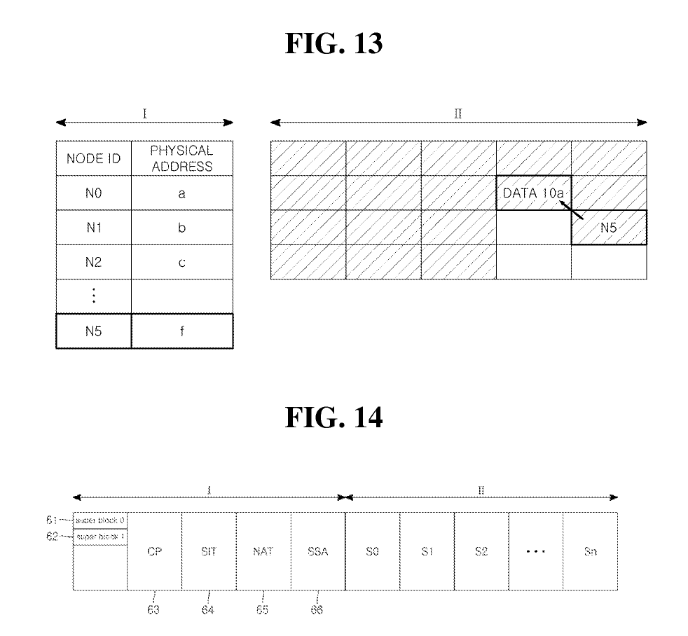

FIGS. 12 and 13 are conceptual diagrams explaining the data management method of a computing system, according to exemplary embodiments. Hereinafter, with reference to FIGS. 12 and 13, a data management method of the computing system will be described.

Referring to FIG. 12, the file system 16 divides the storage device into the first area I and the second area II. As described above, the division of the storage device into the first area I and the second area II may be performed at the time of formatting.

As described above with reference to FIG. 9, the file system 16 may constitute one file with a plurality of data and a plurality of nodes (for example, an Mode, direct nodes, and indirect nodes) related to the plurality of data, and may store the file in the storage device 20. At this time, all the nodes are allocated with node identifiers (NODE ID) from the node address table 65. For example, it is assumed that node identifiers N0 to N5 are allocated to first though fifth nodes, respectively. The node blocks corresponding to N0 to N5 correspond to respective physical addresses a, b, c . . . , and d. The hatched portions illustrated in FIG. 12 are portions in which the plurality of data and the plurality of nodes are written in the second area II.

For example, the fifth node indicated by NODE ID N5 may be a direct node that indicates DATA10, and may be referred to as direct node N5. The direct node N5 is stored in the node block corresponding to the physical address d. In the node address table 65, the physical address d corresponds to the NODE ID N5, indicating that the direct node N5 is stored in the node block corresponding to the physical address d.

FIG. 13 depicts a case in which partial data DATA10 (first data) is corrected to DATA10a (second data) in the file. As mentioned above, information is written in the second area II using the sequential access method. Accordingly, the corrected data DATA10a is stored in a vacant data block at a new location. Further, the direct node N5 is corrected to indicate the data block in which the corrected data DATA10a is stored, and is stored in a vacant node block at a new location corresponding to the physical address f. Information is written in the first area I (metadata area) using the random access method. Accordingly, the node address table 65 is updated such that the physical address f corresponds to the NODE ID N5, overwriting the previous physical address d, indicating that the direct node N5 is stored in the node block corresponding to the physical address f.

Generally, the partial data in the file may be corrected as follows. Among the plurality of data, first data is stored in a first block corresponding to a first physical address. A first direct node indicates (points to) the first data, and the first direct node is stored in a second block corresponding to a second physical address. In the node address table, a first NODE ID of the first direct node corresponds to the second physical address to be stored. Second data is generated by correcting the first data. The second data is written in a third block corresponding to a third physical address that is different from the first physical address. The first direct node is corrected to indicate (point to) the second data, and is written in a fourth block corresponding to a fourth physical address that is different from the second physical address. Further, in the node address table, the second physical address corresponding to the first NODE ID of the first direct node is overwritten, so that the first NODE ID corresponds to the fourth physical address.

In the log structured file system, by using the node address table 65, the amount of data to be corrected and the node can be minimized when correcting the partial data of the file. That is, only the corrected data and the direct nodes that directly indicate the corrected data are written using the sequential access method, and it is not necessary to correct the Mode or the indirect nodes that indicate the direct nodes. This is because the physical addresses corresponding to the direct nodes have been corrected in the node address table 65.

FIG. 14 is a block diagram explaining structure of the storage device of FIG. 1, according to another embodiment of the inventive concept.

Referring to FIG. 14, the second area II may include a plurality of segments S1 to Sn (where, n is a natural number) which are separated from each other. In the respective segments S1 to Sn, data and nodes may be stored without distinction. In comparison, in the computing system according to an embodiment shown in FIG. 10, the storage device includes data segments DS0 and DS1 and node segments NS0 and NS1, which are separated from each other. The plurality of data may be stored in the data segments DS0 and DS1, and the plurality of nodes may be stored in the node segments NS0 and NS1.

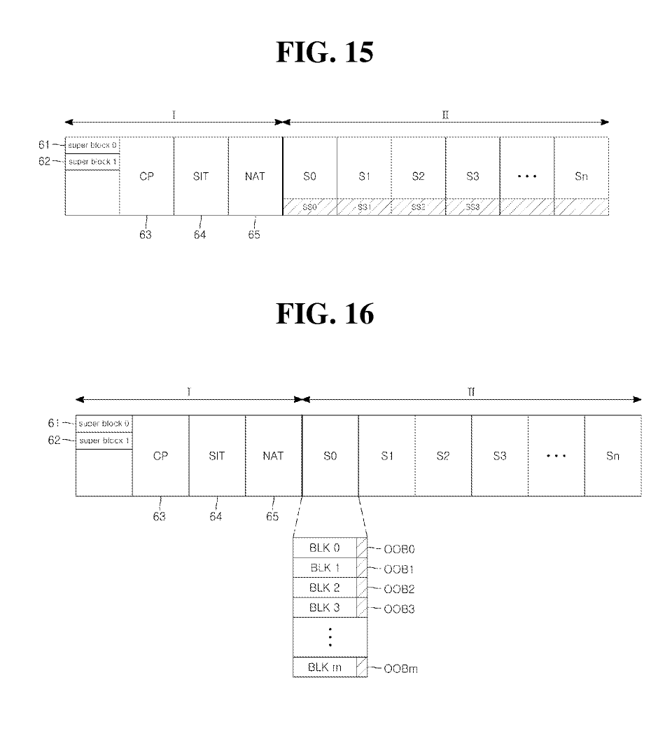

FIG. 15 is a block diagram explaining structure of the storage device of FIG. 1, according to another embodiment of the inventive concept.

Referring to FIG. 15, the first area I does not include the segment summary area (SSA 66 in FIG. 10). That is, the first area I includes the superblocks 61 and 62, the check point area 62, the segment information table 64, and the node address table 65.

The segment summary information may be stored in the second area II. In particular, the second area II includes multiple segments S0 to Sn, and each of the segments S0 to Sn is divided into multiple blocks. The segment summary information may be stored in at least one block SS0 to SSn of each of the segments S0 to Sn.

FIG. 16 is a block diagram explaining structure of the storage device of FIG. 1, according to another embodiment of the inventive concept.

Referring to FIG. 16, the first area I does not include the segment summary area (SSA 66 in FIG. 10). That is, the first area I includes the superblocks 61 and 62, the check point area 62, the segment information table 64, and the node address table 65.

The segment summary information may be stored in the second area II. The second area II includes multiple segments 53, each of the segments 53 is divided into multiple blocks BLK0 to BLKm, and the blocks BLK0 to BLKm may include OOB (Out Of Band) areas OOB1 to OOBm (where, m is a natural number), respectively. The segment summary information may be stored in the OOB areas OOB1 to OOBm.

Hereinafter, a system, to which the computing system according to embodiments of the inventive concept is applied, will be described. The system described hereinafter is merely exemplary, and embodiments of the inventive concept are not limited thereto.

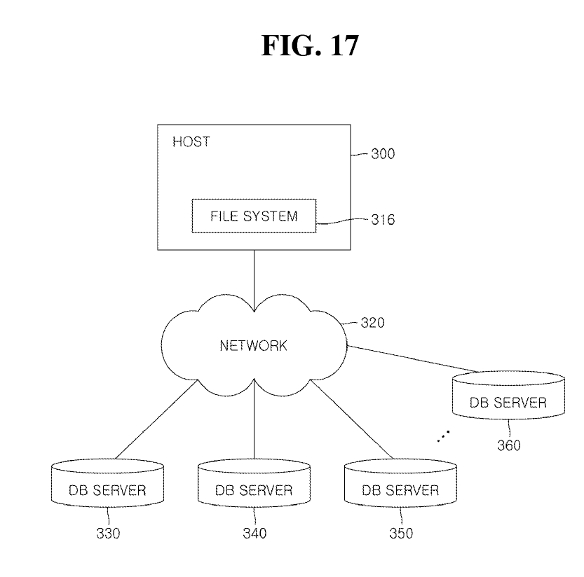

FIG. 17 is a block diagram explaining an example of a computing system, according to embodiments of the inventive concept.

Referring to FIG. 17, a host server 300 is connected to database servers 330, 340, 350, and 360 through a network 320. In the host server 300, a file system 316 for managing data of the database servers 330, 340, 350, and 360 is be installed. The file system 316 may be any one of the file systems as described above with reference to FIGS. 1 to 16.

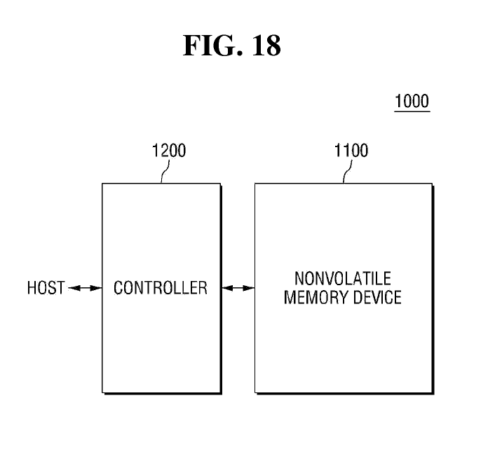

FIGS. 18 to 20 are block diagrams illustrating other examples of a computing system, according to embodiments of the inventive concept.

First, referring to FIG. 18, a storage device 1000 (corresponding to storage device 20 in FIG. 1) includes a nonvolatile memory device 1100 and a controller 1200. The nonvolatile memory device 1100 may be configured to store the above-described superblocks 61 and 62, the check point area 63, the segment information table 64, and the node address table 65.

The controller 1200 is connected to a host and the nonvolatile memory device 1100. The controller 1200 is configured to access the nonvolatile memory device 1100 in response to requests from the host. For example, the controller 1200 may be configured to control read, write, erase, and background operations of the nonvolatile memory device 1100. The controller 1200 is configured to provide an interface between the nonvolatile memory device 1100 and the host. Further, the controller 1200 is configured to drive firmware to control the nonvolatile memory device 1100.

As an example, the controller 1200 may include well known constituent elements, such as random access memory (RAM), a central processing unit, a host interface, and a memory interface. The RAM may be used as at least one of an operating memory of the central processing unit, a cache memory between the nonvolatile memory device 1100 and the host, and a buffer memory between the nonvolatile memory device 1100 and the host. The processing unit controls the overall operation of the controller 1200.

The controller 1200 and the nonvolatile memory device 1100 may be integrated into one semiconductor device. For example, the controller 1200 and the nonvolatile memory device 1100 may be integrated into one semiconductor device to configure a memory card. For example, the controller 1200 and the nonvolatile memory device 1100 may be integrated into one semiconductor device to configure a memory card, such as a PC card (e.g., a Personal Computer Memory Card International Association (PCMCIA)), a compact flash (CF) card, a smart media card (SM or SMC), a memory stick, a multimedia card (MMC, RS-MMC, MMCmicro), a SD card (SD, miniSD, microSD, or SDHC), a universal flash storage device (UFS), or the like.

The controller 1200 and the nonvolatile memory device 1100 may be integrated into one semiconductor device to configure a Solid State Drive (SSD). The SSD includes a storage device that is configured to store data in a semiconductor memory. When the system 1000 is used as a SSD, the operating speed of the host that is connected to the 1000 can be significantly improved.

As another example, the system 1000 may be provided as one of various constituent elements of electronic devices, such as a computer, a Ultra Mobile PC (UMPC), a work station, a net-book, a Personal Digital Assistant (PDA), a portable computer, a web tablet, a wireless phone, a mobile phone, a smart phone, an e-book, a Portable Multimedia Player (PMP), a portable game machine, a navigation device, a black box, a digital camera, a 3-dimensional television receiver, a digital audio recorder, a digital audio player, a digital picture recorder, a digital picture player, a digital video recorder, a digital video player, a device capable of transmitting and receiving information in a wireless environment, one of various electronic devices constituting a home network, one of various electronic devices constituting a computer network, one of various electronic devices constituting a telematics network, an RFID device, or one of various electronics devices constituting a computing system.

In addition, the nonvolatile memory device 1100 or the system 1000 may be mounted as various types of packages. For example, the nonvolatile memory device 1100 and/or the system 1000 may be packaged and mounted as PoP (Package on Package), Ball grid arrays (BGAs), Chip scale packages (CSPs), Plastic Leaded Chip Carrier (PLCC), Plastic Dual In Line Package (PDIP), Die in Waffle Pack, Die in Wafer Form, Chip On Board (COB), Ceramic Dual In Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), or the like.

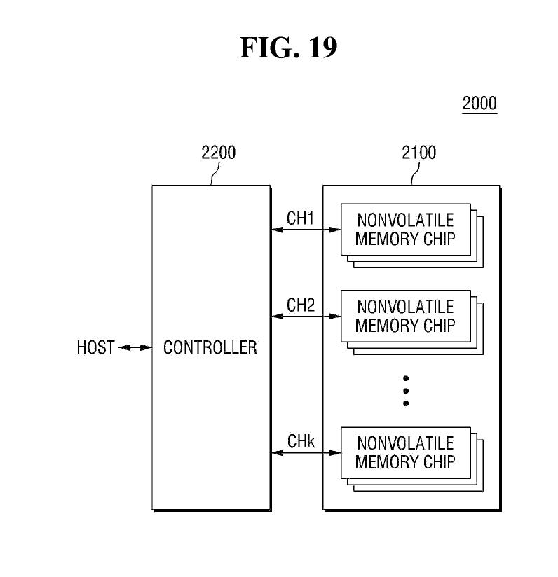

Then, referring to FIG. 19, a system 2000 includes a non-volatile memory device 2100 and a controller 2200. The nonvolatile memory device 2100 includes multiple nonvolatile memory chips. The memory chips are divided into multiple groups. The respective groups of the nonvolatile memory chips are configured to communicate with the controller 2200 through one common channel. For example, it is illustrated that the nonvolatile memory chips communicate with the controller 2200 through first to k-th channels CH1 to CHk.

In FIG. 19, multiple nonvolatile memory chips are connected to one channel of the first to kth channels CH1 to CHk. However, it will be understood that the system 2000 may be modified such that one nonvolatile memory chip is connected to one channel of the first to kth channels CH1 to CHk.

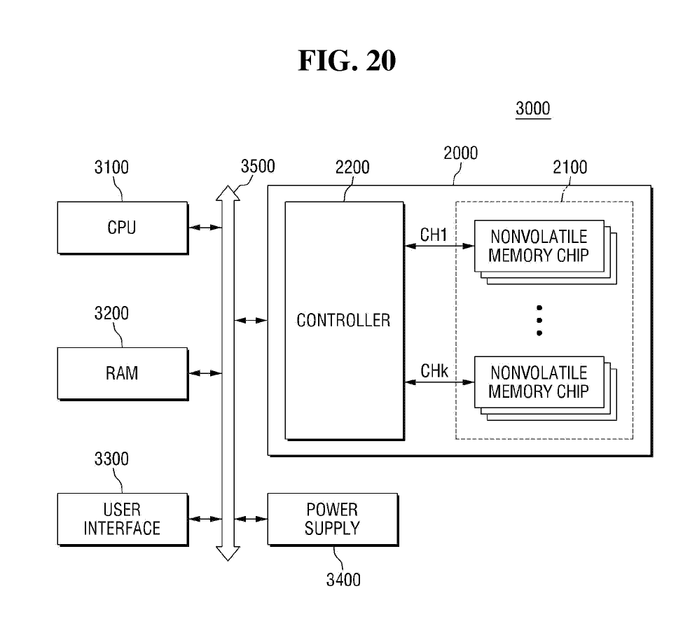

Referring to FIG. 20, a system 3000 includes a central processing unit (CPU) 3100, a random access memory (RAM) 3200, a user interface 3300, a power supply 3400, and the system 2000 of FIG. 19. The system 2000 is electrically connected to the CPU 3100, the RAM 3200, the user interface 3300, and the power supply 3400 through a system bus 3500. Data which is provided through the user interface 3300 or is processed by the CPU 3100 is stored in the system 2000.

FIG. 20 illustrates that the nonvolatile memory device 2100 is connected to the system bus 3500 through the controller 2200. However, the nonvolatile memory device 2100 may be configured to be directly connected to the system bus 3500.

While the inventive concept has been described with reference to illustrative embodiments, it will be apparent to those of ordinary skill in the art that various changes and modifications may be made without departing from the spirit and scope of the inventive concept. Therefore, it should be understood that the above embodiments are not limiting, but illustrative.

What is claimed is:

1. A computing system, comprising:
a virtual file system configured to provide a first data request to read first file data; and
a file system configured to receive the first data request, to read first metadata and second metadata from a storage device in response to the first data request, and then to read first file data corresponding to the first metadata and second file data corresponding to the second metadata from the storage device.

2. The computing system of claim 1, wherein the second file data is data that is expected to be read next to the first data.

3. The computing system of claim 2, wherein the second file data is located adjacent the first file data.

4. The computing system of claim 1, wherein the file system is further configured to determine whether to read only the first metadata or to read the first metadata and the second metadata.

5. The computing system of claim 4, wherein when third file data previously requested by the virtual file system and the first file data currently requested are continuous data with each other, the file system is configured to read the first metadata and the second metadata.

6. The computing system of claim 4, wherein when third file data previously requested by the virtual file system and the first file data currently requested are not continuous data with each other, the file system is configured to read only the first metadata.

7. The computing system of claim 1, further comprising:
a user application configured to provide the first data request to read the first file data,
wherein the virtual file system is further configured to provide the first data request to read the first file data and a second data request to read the second file data, and
wherein the file system is further configured to receive the first data request and the second data request, to read the first metadata and the second metadata from the storage device, and then to read the first file data corresponding to the first metadata and the second file data corresponding to the second metadata from the storage device.

8. The computing system of claim 7, wherein the file system is further configured to provide the read first file data and the read second file data to the virtual file system, and the virtual file system is further configured to provide the first file data to the user application.

9. The computing system of claim 8, wherein the user application is further configured to provide the second data request to read the second file data, and the virtual file system is further configured to receive the second data request and to provide the previously provided second file data to the user application in response.

10. The computing system of claim 1, wherein the storage device is a Solid State Drive (SSD).

11. The computing system of claim 1, wherein the file data includes a plurality of data, and the metadata includes a plurality of nodes including positions of the plurality of data.

12. The computing system of claim 11, wherein the storage device comprises a first area located on a front portion and a second area located on a rear portion, and
wherein the plurality of data and the plurality of nodes are stored in the second area, and a node address table is stored in the first area, the node address table including a plurality of node identifiers corresponding to the nodes and a plurality of physical addresses corresponding to the plurality of node identifiers.

13. The computing system of claim 12, wherein write operations in the second area are performed using a sequential access method, and write operations in the first area are performed using a random access method.

14. The computing system of claim 12, wherein the second area includes a plurality of segments, a plurality of pages are stored in each of the segments, and
wherein a segment information table is stored in the first area, the segment information table including the number of valid pages of each of the segments and bitmaps of the plurality of pages.

15. The computing system of claim 12, wherein the second area includes a plurality of segments, each of the segments being divided into a plurality of blocks, and
wherein a segment summary area is stored in the first area, the segment summary area including information on the nodes to which the plurality of blocks of each of the segments belong.

16. A data management method of a computing system comprising a storage device, the method comprising:
receiving a first data request to read first file data from the storage device;
reading first metadata and second metadata from the storage device in response to the request;
reading first file data corresponding to the first metadata and second file data corresponding to the second metadata from the storage device; and
providing the first file data to a user application.

17. The data management method of claim 16, further comprising:
subsequently receiving a second data request initiated by the user application to read the second file data from the storage device; and
providing the previously read second file data to the user application in response to the second data request.

18. The data management method of claim 16, wherein the second file data is located adjacent the first file data in the storage device.

19. The data management method of claim 16, further comprising:
determining whether the first file data has continuity with previously requested data;
reading the first metadata and the second metadata from the storage device when the first file data has continuity with the previously requested data; and
reading only the first metadata from the storage device when the first file data does not have continuity with the previously requested data.

20. A computing system, comprising:
a storage device configured to store a plurality of data and a plurality of metadata corresponding to the plurality of data; and
a host configured to communicate with the storage device, the host comprising:
a user application configured to provide a first data request to read first file data of the plurality of data in the storage device;
a virtual file system configured to receive the first data request from the user application; and
a file system configured to receive the first data request from the virtual file system, to read first metadata and second metadata from the storage device in response to the first data request, and then to read the first file data from the storage device using the first metadata and second file data of the plurality of data from the storage device using the second metadata,
wherein one of the virtual file system and the file system is configured to provide a second data request for reading the second file data in response to the first data request.
